(19) United States
(12) Patent Application Publication
(10) Pub. No.: US 2006/0073079 A1
(43) Pub. Date: Apr. 6, 2006

(54) Apparatus for the polymerization of biological specimens in the context of cryosubstitution

(76) Inventors: Hubert Goll, St. Polten (AT); Paul Wurzinger, Deutsch-Wagram (AT)

Correspondence Address: Howard M. Ellis;Simpson & Simpson, PLLC, 5555 Main Street, Williamsville, NY, 14221, US

(21) Appl. No.: 11/230,788

(22) Filed: Sep. 20, 2005

(30) Foreign Application Priority Data
Sep. 24, 2004 (DE) 10 2004 046 762.5

(51) Int. Cl. B01J 19/00

(52) U.S. Cl. 422/99; 422/102; 422/130

(57) ABSTRACT

An apparatus for the polymerization of biological specimens in the context of cryosubstitution is disclosed. Also disclosed is the use of diodes having UV components for the polymerization of biological specimens in the context of cryosubstitution. A cooled chamber (6) is provided, in which at least one specimen carrier (2) having a biological specimen (4) is received. At least one diode (7), which emits light having UV components and is arranged in such a way that the light is directed onto the biological specimens (4), is mounted on a constituent part (9) of the cooling apparatus (5).

### CROSS REFERENCE TO RELATED APPLICATIONS

This application claims priority of the German patent application 10 2004 046 762.5 filed Sep. 24, 2004, which is incorporated by reference herein.

### FIELD OF THE INVENTION

The invention concerns an apparatus for the polymerization of biological specimens in the context of cryosubstitution.

### BACKGROUND OF THE INVENTION

The Leica EM AFS discloses a device according to the existing art. A Dewar vessel is filled with liquid nitrogen, the Dewar neck having a chamber that is cooled to a specific temperature. The desired temperature is set via a control circuit and built-in heating elements. The substitution process begins at approximately −90° C. The frozen specimen is transferred into the chamber, for which purpose multiple different containers can be provided with which the specimens are immersed into a substitution medium, usually acetone or methanol. At this low temperature the slow process of substitution begins, in which the frozen water in the specimen is replaced by the solvent without the occurrence of recrystallization. During this process the temperature is then slowly raised, and the medium is exchanged and ultimately replaced with a low-temperature embedding medium. A UV lamp is placed onto the chamber for polymerization of the low-temperature embedding medium. The various containers for cryosubstitution and embedding are disclosed in the catalog for the Leica EM AFS.

Polymerization according to the existing art is performed with the aid of UV radiation that is emitted from gas discharge lamps. Originally the radiation sources were built into housings that also contained the specimens and were placed, populated therewith, into a cooling apparatus (e.g. cooling chest). Today the lamps are instead used in the form of an attachment onto a cooled chamber in which the entire substitution process is performed.

Essentially two types of lamps are used; both types have their emission maximum at a wavelength of approx. 365 nm. The “black light” lamp type has a very narrow emission spectrum that lies almost entirely in the UV. The “actinic” lamp type (e.g. Philips TLAD 15W/05) has a broader spectrum that continues into both the deeper UV and the visible region. The developers of the plastics most often used in the substitution processes (Lowi Co., Germany) indicate a wavelength of 360 nm as critical for polymerization.

The lamps available on the market have too high an intensity for the polymerization process. Because the intensity of fluorescent lamps is very difficult to control electronically, the intensity has hitherto been adapted in geometric fashion, by shading and multiple reflection of the radiation and by increasing the distance between lamp and preparation.

The greatest disadvantage of the existing art relevant to the present invention is the relatively large volume occupied by the lamps used hitherto. The light-emitting diodes described in the present invention are, in contrast, small, and can be positioned substantially closer to the specimens, and in fact in the substitution chamber itself, without interfering with specimen manipulation. Only with this invention can integration into the chamber be effected in such a way that the substitution process need not be interrupted in order to attach a lamp.

A further disadvantage of the lamps used hitherto is the fact that the small gas discharge tubes preferred for use are (unlike large ones) relatively unstable, and can exhibit severe emission fluctuations and aging. The service life of the tubes is much shorter than that of common light-emitting diodes.

The gas discharge lamps are substantially more sensitive to vibration than are the diodes, and can break if handled improperly; this can result both in injury and in the release of mercury.

Gas discharge lamps are easy to operate at high voltages or line voltage, whereas operation at low voltage necessitates relatively complex electronics and is usually also associated with performance losses and a reduction in service life.

Although the power dissipation exhibited by gas discharge lamps is very low as compared with incandescent lamps, it is high as compared with light-emitting diodes. This is a decisive disadvantage especially for low-temperature applications, since a higher power dissipation from the lamp must be compensated for by higher cooling output.

### SUMMARY OF THE INVENTION

It is therefore the object of the present invention to make available an apparatus for cryosubstitution of biological specimens that is easy to use, possesses a long service life, and is safe for a user to handle.

The above object is achieved by an for the polymerization of biological specimens in the context of cryosubstitution. The apparatus comprises a cooling apparatus; a cooled chamber that is embodied in the cooling apparatus and serves to receive at least one specimen carrier which holds a biological specimen; at least one diode that emits light having UV components is mounted on a constituent part of the cooling apparatus and is arranged in such a way that the light is directed directly or indirectly onto the biological specimens and that a homogeneous illumination of the chamber is achieved.

A further object of the invention is an apparatus that uses a plurality of diodes having UV components for the polymerization of embedding material for biological specimens in the context of cryosubstitution.

The object is achieved by an apparatus comprising a plurality of diodes having UV components for the polymerization of embedding material for biological specimens in the context of cryosubstitution.

The use of diodes is advantageous because a lamp housing that is to be put in place can be operated at low voltage, making attachment and removal as simple and safe as possible. As compared with gas discharge lamps or incandescent lamps, light-emitting diodes have a very low power dissipation. In the context of a low-temperature application, a lamp power dissipation therefore does not need to be compensated for by higher cooling output.

A further result of the use of diodes is the possibility of a control system, thus allowing the intensity to be adapted to the plastic being used. A further advantage is direct integration of the diodes into a cryosubstitution chamber or into an add-on unit used therewith, rendering superfluous any interruption of the process in order to attach the UV lamp.

Suitable diodes or light-emitting diodes (LEDs) are those that have a UV emission component. The diodes used can be obtained in large quantities, with reliable quality, and at favorable prices. Diodes do not, however, have the wavelength maximum of 360 nm that is optimum for polymerization. It has been demonstrated that longer-wavelength radiation is also suitable for polymerization. Diodes having an emission maximum at 400 nm are thus also suitable for polymerization. The best price/performance ratio at present can be achieved with diodes having emission maxima around 380-385 nm.

The apparatus for the polymerization of biological specimens in the context of cryosubstitution encompasses a cooled chamber. A container is embodied in the cooled chamber and configured to receive at least one specimen carrier having a biological specimen. At least one diode that emits light having UV components is mounted on a constituent part of the cooled chamber. The diodes are arranged in such a way that the light is directed onto the biological specimens.

The constituent part in which the diodes are mounted is a separate constituent part that can be placed, for polymerization, onto the cooled chamber.

A further advantageous embodiment is that the constituent part in which the diodes are mounted is immovably joined to the cooled chamber. A further possibility is that the diodes are immovably mounted in a wall of the cooled chamber.

The constituent part in which the diodes are mounted can furthermore be a subunit or add-on unit of the cooled chamber.

One advantageous arrangement of the diodes is that the multiple diodes are arranged annularly, the diodes possessing a large emission angle so that a homogeneous illumination of the cooled chamber and the container is achievable.

Also provided is a sensor which determines the status in terms of whether the cooled chamber is closed, or the separate constituent part having the diodes is mounted on the cooled chamber, or the add-on module of the cooled chamber is mounted. The diodes are or are not activated based on the sensor signal.

Also provided is a control unit that controls the diodes and the cooled chamber. The control unit regulates the intensity of the diodes by varying the diode current or by pulsed operation.

### BRIEF DESCRIPTION OF THE DRAWINGS

Further advantages and advantageous embodiments of the invention may be inferred from the dependent claims and are the subject matter of the Figures below and the descriptions thereof, in which Figures individually:

FIG. 1 schematically depicts a first embodiment of the invention;

FIG. 2 schematically depicts a second embodiment of the invention;

FIG. 3 schematically depicts a third embodiment of the invention;

FIG. 4 is a perspective view of the specimen carrier for cryosubstitution and embedding that can be used in the context of the present invention; and

FIG. 5 is a perspective view of the container for cryosubstitution and embedding, multiple specimen carriers being inserted into the container.

### DETAILED DESCRIPTION OF THE INVENTION

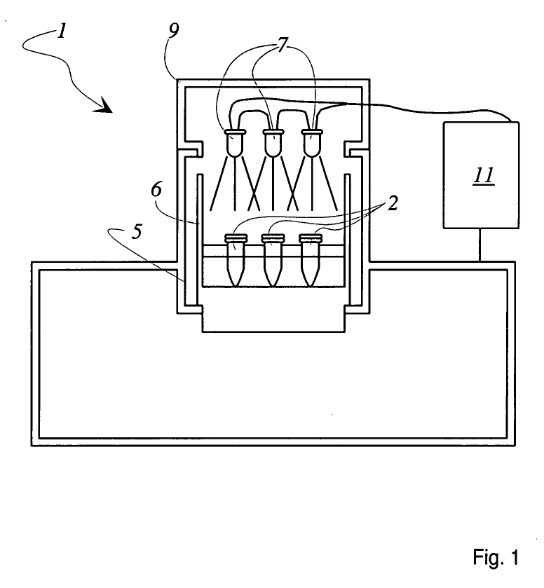

FIG. 1 schematically depicts a first embodiment of the invention. Apparatus 1 for the polymerization of biological specimens in the context of cryosubstitution encompasses a cooling apparatus 5. At least one chamber 6 can be inserted into cooling apparatus 5. Chamber 6 serves to receive at least one specimen carrier 2 that contains the biological specimen 4. Mounted on a constituent part of cooling apparatus 5 or of cooled chamber 6 is at least one diode 7 that emits light having UV components and is arranged in such a way that the light is directed onto the biological specimens and onto specimen carrier 2. The constituent part in which diodes 7 are mounted is a separate constituent part 9 that is placed, for polymerization, onto cooling apparatus 5. Multiple diodes 7 are provided, and are arranged in such a way that a homogeneous illumination of chamber 6 is achievable. Also provided is a control unit 11 that controls diodes 7 and cooled chamber 6. Light-emitting diodes or diodes 7 that at least partly exhibit an emission in the ultraviolet spectral region, and are therefore suitable for the polymerization of electron-microscope preparations or specimens infiltrated with synthetic resins or monomers at low temperatures (−60° C. to 0° C.), are used. Diodes 7 preferably have an emission maximum at a wavelength between 360 nm and 400 nm. Other diodes 7 whose emission spectrum lies partly in this spectral region can, however, also be used. In the exemplifying embodiment described here, diodes 7 are incorporated into a separate constituent part 9 that is placed, for polymerization, onto cooled chamber 6 in which the preparations are cooled. Multiple diodes 7 are preferably used here in order to obtain a homogeneous illumination. For rapid polymerization of small specimens, however, individual diodes 7 can also be incorporated in such a way that are directly precisely onto the preparation.

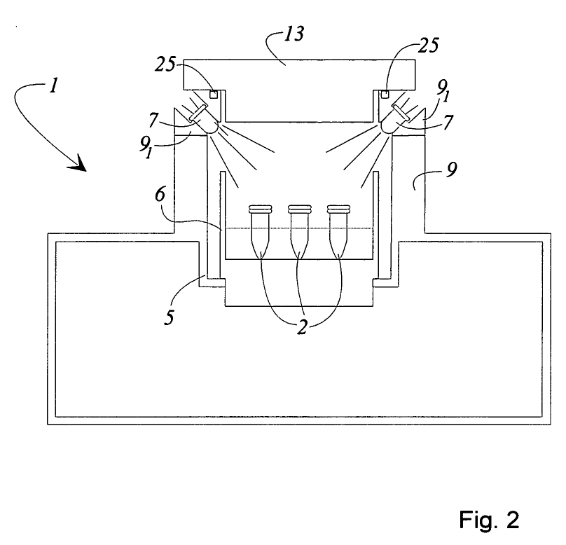

FIG. 2 schematically depicts a second embodiment of the invention. Constituent part 9 in which diodes 7 are mounted is immovably joined to cooling apparatus 5. Diodes 7 are thus integrated into cooled chamber 6. In the embodiment depicted here, diodes 7 are integrated into a chamber wall 5₁ of cooling apparatus 5. It is particularly advantageous if cooling apparatus 5 possesses a cylindrical chamber wall 5₁. Diodes 7 can furthermore be incorporated into a different constituent part 9 joined fixedly to chamber 6, or into chamber 6 itself. For space reasons, here as well it is advantageous to use individual diodes 7 to illuminate predefined positions for the preparations. In the embodiment depicted here, an annular arrangement of diodes 7 having a large emission angle is depicted. This arrangement also allows a homogeneous illumination of the entire cooled chamber 6 to be achieved. In this embodiment, diodes 7 are mounted on a support ring 9₁, thus yielding the annular arrangement of diodes 7. Diodes 7 are switched on only for polymerization, but remain permanently in their positions. Manipulation of the lamp housing when polymerization begins is therefore superfluous, and polymerization can even be started in program-controlled fashion, i.e. without direct intervention by the user. Control system 11 is utilized for program control of the entire apparatus. Cooled chamber 6 can be closed off or sealed with a chamber cover 13. Electronic control system 11 serves to regulate the intensity of the radiation emitted by diodes 7. Diodes 7 can be regulated by controlling the diode current or by pulsed activation of diodes 7.

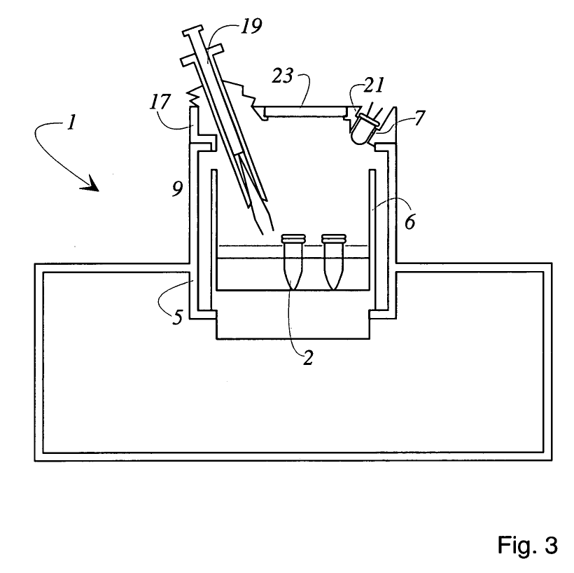

FIG. 3 schematically depicts a third embodiment of the invention. Here diodes 7 are integrated into a subunit 17 or add-on unit that is not immovably joined to cooling apparatus 5. Subunit 17 or the add-on unit is placed onto cooling apparatus 5 before polymerization. Subunit 17 or the add-on unit can also be used for other process steps in addition to polymerization. Subunit 17 or the add-on unit can likewise be equipped with other functions, for example with an integrated manipulator 19. Subunit 17 or the add-on unit is used in the final process steps, i.e. before polymerization; the integrated diodes 7 thus make possible (as already indicated for the embodiment described in FIG. 2) a program-controlled polymerization start without direct user intervention. Diodes 7 are incorporated into subunit 17 or the add-on unit of cooled chamber 6. In the form depicted, subunit 17 or the add-on unit encompasses a housing 21 that is equipped with a viewing window 23 through which a user can make modifications to the specimens using manipulator 19. Subunit 17 or the add-on unit can also be embodied differently, however; in particular, it can also be the chamber cover 13.

Diodes 7 have a radiation intensity that is better adapted to the polymerization process than are conventional lamps. Shading measures such as those common in the context of gas discharge lamps can therefore be omitted. Higher intensities can very easily be achieved with diodes 7 by providing multiple diodes 7. In addition, the intensity is very easy to control by regulating the operating current or by pulse width modulation.

It is known that the shorter the wavelength of electromagnetic radiation, the more damaging it is to tissue (and thus to the user). The slightly longer emission wavelength of diodes 7 thus contributes to minimizing the potential hazard to the user. Diodes 7 can be arranged in different ways with respect to the biological specimen. Care should be taken in this context that polymerization proceeds as homogeneously as possible, that the embedded tissue of the specimen is damaged as little as possible by the UV radiation, and that the user of apparatus 1 is likewise protected from the UV radiation. Multiple diodes 7 are, in this context, arranged in such a way that a homogeneous illumination of the container is achievable. Also conceivable is an arrangement in which multiple diodes 7 are provided, arranged in such a way that one individual diode 7 is directed onto each biological specimen. A further possibility is for the multiple diodes 7 to be arranged annularly, diodes 7 possessing a large emission angle so that homogeneous illumination of cooled chamber 6 and of container 2 is achievable. To protect a user from possible damage by the UV radiation, a sensor 25 (see FIG. 2) is provided which determines the status in terms of whether cooling apparatus 5 or cooled chamber 6 is closed, or the subunit having diodes 7 is mounted on cooling apparatus 5. Sensor 25 ensures that diodes 7 can be switched on only when cooled chamber 6 is closed or subunit 17 is placed onto cooling apparatus 5. Diodes 7 are operated at low voltage, and can be switched on and off by the user or by a program. The user is thereby also protected from electrical shocks.

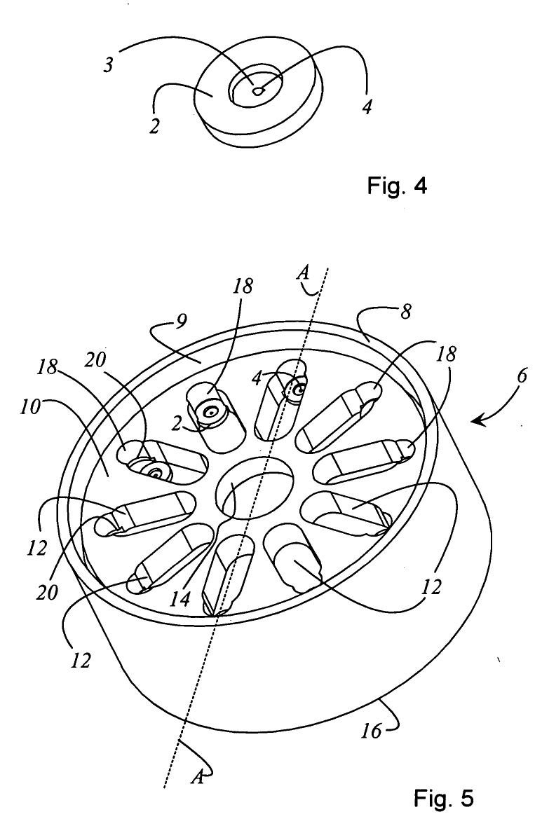

In the embodiments depicted in FIGS. 1 to 3, the specimens are introduced into a specimen carrier 2 that is embodied as a PCR vessel. This is not, however, to be construed as a limitation of the invention. It is self-evident to anyone skilled in the art that other specimen carriers suitable for polymerization with light having UV components can also be used. A further embodiment of a specimen carrier is shown in FIG. 4.

FIG. 4 is a perspective view of a specimen carrier 2 carrying a specimen 4. Specimen carrier 2 is of annular configuration and carries specimen 4 in a depression 3. Specimen 4 has a diameter of approximately 1.2 mm and a thickness of approximately 0.2 mm.

FIG. 5 is a perspective view of an embedding mold 26 for cryosubstitution and embedding, in which multiple specimen carriers 2 can be received. Embedding mold 26 is cylindrical in shape and possesses a sidewall 8 and a base 16. The embedding mold 26 is open at the end opposite base 16. Multiple troughs 12 are configured in the interior of embedding mold 26. It is particularly advantageous if troughs 12 are configured in a trough plate 10 that is removable from the inner region of embedding mold 6. In the embodiment depicted here, trough plate 10 possesses a central introduction and extraction opening 14 through which the chemicals or media necessary for cryosubstitution and embedding can be delivered and extracted. In this embodiment, troughs 12 are arranged radially around introduction/extraction opening 14. Toward side wall 8 of embedding mold 6, troughs 12 possess a tapered end 18. Tapered end 18 is configured with a step 20 with which the specimen carrier is held in the trough. One specimen carrier 4 is placed into each trough 12, and slid toward the tapering end 18 until it comes into contact against step 20. Specimen carriers 2 are thereby distributed radially along sidewall 8 of embedding mold 6. With the radial distribution of specimen carriers 2 in embedding mold 6, a radial distribution of the diodes is also recommended.

What is claimed is:

1. An apparatus for the polymerization of biological specimens in the context of cryosubstitution comprises a cooling apparatus; a cooled chamber that is embodied in the cooling apparatus and serves to receive at least one specimen carrier which holds a biological specimen; at least one diode that emits light having UV components is mounted on a constituent part of the cooling apparatus and is arranged in such a way that the light is directed directly or indirectly onto the biological specimens and that a homogeneous illumination of the chamber is achieved.

2. The apparatus according to claim 1, wherein the constituent part in which the diodes are mounted is a separate constituent part that can be placed, for polymerization, onto the cooling apparatus or the cooled chamber.

3. The apparatus according to claim 1, wherein the constituent part in which the diodes are mounted is immovably joined to the cooled chamber.

4. The apparatus according to claim 1, wherein the diodes are immovably mounted in a chamber wall of the cooling apparatus.

5. The apparatus according to claim 1, wherein the constituent part in which the diodes are mounted is a subunit or add-on unit of the cooled chamber or of the cooling apparatus.

6. The apparatus according to claim 5, wherein the subunit or add-on unit of the cooled chamber encompasses a manipulator module and the manipulator module possesses a housing; and the housing is configured with a viewing window.

7. The apparatus according to claim 1, wherein multiple diodes are arranged annularly, the diodes possessing a large emission angle so that a homogeneous illumination of the cooled chamber is achievable.

8. The apparatus according to claim 1, wherein a sensor is provided which determines the status in terms of whether the cooling apparatus or cooled chamber is closed, or the separate constituent part having the diodes is mounted on the cooled chamber, or the add-on unit of the cooled chamber is mounted.

9. The apparatus according to claim 1, wherein a control unit is provided that controls the diodes and the cooled chamber.

10. The apparatus according to claim 9, wherein the control unit regulates the intensity of the diodes by varying the diode current or by pulsed operation.

15. The apparatus according to claim 1, wherein in the chamber at least one embedding mold is used, which is embodied to receive at least one specimen carrier having a specimen; multiple troughs are embodied in the embedding mold, each to receive one specimen carrier; and each of the troughs is equipped with a supply conduit so that a connection among the troughs exists.

16. An apparatus comprising a plurality of diodes having UV components for the polymerization of embedding material for biological specimens in the context of cryosubstitution.
